(19) United States
(12) Patent Application Publication
(10) Pub. No.: US 2010/0271335 A1
(43) Pub. Date: Oct. 28, 2010

(54) DISPLAY DEVICE HAVING OPTICAL SENSORS

(76) Inventors: Toshimitsu Gotoh, Osaka (JP); Akizumi Fujioka, Osaka (JP); Kei Oyobe, Osaka (JP); Takahiro Nakayama, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/742,154

(22) PCT Filed: Dec. 10, 2008
(86) PCT No.: PCT/JP2008/072391

§ 371 Date: May 10, 2010

(30) Foreign Application Priority Data
Jan. 25, 2008 (JP) 2008-015050

(51) Int. Cl. G09G 3/36; G09G 5/00; G06F 3/042

(52) U.S. Cl. 345/175; 345/207; 345/88

(57) ABSTRACT

A liquid crystal panel 11 with built-in sensors includes, in a pixel array 18, a plurality of pixel circuits and a plurality of optical sensors arranged two-dimensionally. When the liquid crystal panel 11 is formed of CG silicon, the light receiving sensitivity of the optical sensor is high for blue light but becomes low for red or green light. A display data processing unit 12 corrects a gradation having a value that is less than or equal to a predetermined value, to high for a blue component contained in display data D1. The display data processing unit 12 corrects only data displayed in a recognition area set in a display screen out of the blue component. Thus, even when the display image is dark, it can be converted to an image easy to recognize, a touch position can be detected properly irrespective of the display image, and a change of the display image by correction can be limited to the change of a specific color in a specific area.

### TECHNICAL FIELD

The present invention relates to a display device and more particularly to a display device having a plurality of optical sensors provided in a display panel.

### BACKGROUND ART

In recent years, electronic devices that can be operated by touching a screen with a finger, a pen, etc., have proliferated. In addition, for a method of detecting a touch position on a display screen, a method is known in which a plurality of optical sensors are provided in a display panel and a shadow image that is created when a finger or the like approaches a screen is detected using the optical sensors.

In the method of detecting a shadow image, when the illumination of outside light is low (the surroundings are dark), it is difficult to distinguish between a shadow image and a background in an image obtained by the optical sensors and thus a touch position may not be able to be detected properly. Hence, for a display device including a backlight, a method is also known in which a reflection image that is created when backlight light hits a finger is detected using optical sensors. A display device having a plurality of optical sensors provided in a display panel is described in, for example, Patent Document 1.

[Patent Document 1] Japanese Patent Application Laid-Open. No. 2007-102154

### DISCLOSURE OF THE INVENTION

### Problems to be Solved by the Invention

However, a conventional display device provided with optical sensors has a problem that the detection accuracy for a touch position decreases when a displayed image is dark. For example, in a liquid crystal display device provided with optical sensors, light having passed through a liquid crystal layer enters the optical sensors provided in a liquid crystal panel (see FIGS. 4A and 4B which will be described later).

However, when displayed gradation is dark (when the light transmittance of the liquid crystal layer is low), the amount of light that passes through the liquid crystal layer and enters the optical sensors decreases and thus the amount of light detected by the optical sensors also decreases. Hence, when displayed gradation is dark, a reflection image detected by using the optical sensors is darkened, decreasing the detection accuracy for a touch position. An object of the present invention is therefore to provide a display device that can properly detect a touch position irrespective of a displayed image.

### Means for Solving the Problems

According to a first aspect of the present invention, there is provided a display device having a plurality of optical sensors, the display device comprising: a display panel including a plurality of pixel circuits and a plurality of optical sensors which are arranged two-dimensionally; a display data processing unit that corrects a color component with a high light reception sensitivity of the optical sensors among a plurality of color components which are included in display data; and a drive circuit that performs an operation of writing a signal according to the corrected display data into the pixel circuits and an operation of reading a signal according to an amount of received light, from the optical sensors.

According to a second aspect of the present invention, in the first aspect of the present invention, the display data processing unit corrects a gradation value included in a correction target color component that is less than or equal to a predetermined value, to a high value.

According to a third aspect of the present invention, in the second aspect of the present invention, the display data processing unit corrects only such data for the correction target color component that is displayed in a recognition area set on a display screen.

According to a fourth aspect of the present invention, in the third aspect of the present invention, the display data processing unit receives recognition area data from an external source and corrects only such data for the correction target color component that is displayed in a recognition area which is identified by using the recognition area data.

According to a fifth aspect of the present invention, in the fourth aspect of the present invention, the display device further comprises a sensor data processing unit that performs an image recognition process on a scanned image generated based on the signal read from the optical sensors, to detect an object included in the scanned image, and outputs rough position data representing a rough position of the object in the scanned image, wherein the display data processing unit corrects only such data for the correction target color component that is displayed in an area which is identified by using the recognition area data and the rough position data.

According to a sixth aspect of the present invention, in the first aspect of the present invention, the display device further comprises a sensor data processing unit that performs an image recognition process on a scanned image generated based on the signal read from the optical sensors, to detect an object included in the scanned image.

According to a seventh aspect of the present invention, in the sixth aspect of the present invention, the display device further comprises a backlight that irradiates light to a back surface of the display panel, wherein the sensor data processing unit detects at least a reflection image of the object.

According to an eighth aspect of the present invention, in the first aspect of the present invention, the display panel is a liquid crystal panel formed of CG (Continuous Grain) silicon, and the display data processing unit corrects a blue component among the plurality of color components which are included in the display data.

According to a ninth aspect of the present invention, there is provided a method of driving a display device having a display panel which includes a plurality of pixel circuits and a plurality of optical sensors which are arranged two-dimensionally, the method comprising the steps of: correcting a color component with a high light reception sensitivity of the optical sensors among a plurality of color components which are included in display data; writing a signal according to the corrected display data into the pixel circuits; and reading a signal according to an amount of received light, from the optical sensors.

### EFFECT OF THE INVENTION

According to the first or ninth aspect of the present invention, by correcting such a color component in display data that has a high light reception sensitivity of the optical sensors, a displayed image can be converted to an image that is easy to recognize and thus a touch position can be detected properly irrespective of the displayed image. In addition, by correcting only a specific color component, a change in display screen made by correction can be limited to only a change in specific color.

According to the second aspect of the present invention, by correcting low gradation values included in a correction target color component to high values, even when a displayed image is dark and accordingly the amount of light detected by the optical sensors is small, the amount of light detected by the optical sensors is increased to brighten an object image, enabling to properly detect a touch position. In addition, by correcting only low gradation values included in a specific color component, a change in display screen made by correction can be limited to only a smaller change in specific color.

According to the third aspect of the present invention, by correcting only such data for the correction target color component that is displayed in a recognition area set on a display screen, a touch position can be detected properly while a change in display screen made by correction is limited to only within a specific area.

According to the fourth aspect of the present invention, by identifying a recognition area based on recognition area data which is provided from a source external to the display device, a touch position can be detected properly while a change in display screen made by correction is limited to within a specific area which is set in a free position from the source external to the display device.

According to the fifth aspect of the present invention, by performing an image recognition process on a scanned image, an object included in the scanned image can be detected by the display device. In addition, by determining correction target data by referring to rough position data which is obtained in the display device in addition to recognition area data which is received from a source external to the display device, a touch position can be detected properly while a change in display screen made by correction is limited to only near an object.

According to the sixth aspect of the present invention, by performing an image recognition process on a scanned image, an object included in the scanned image can be detected by the display device.

According to the seventh aspect of the present invention, when a reflection image of an object is detected, a scanned image is darkened and thus a problem of a decrease in the detection accuracy for a touch position becomes remarkable. However, even in such a case, by correcting a color component in display data that has a high light reception sensitivity of the optical sensors, a displayed image can be converted to an image that is easy to recognize and thus a touch position can be detected properly irrespective of the displayed image.

According to the eighth aspect of the present invention, when a liquid crystal panel including a plurality of optical sensors is formed of OG silicon, the light reception sensitivity of the optical sensors is high for blue light. Thus, by correcting a blue component included in display data, a displayed image can be converted to an image that is easy to recognize and thus a touch position can be detected properly irrespective of the displayed image. Particularly, by correcting only a blue component, a change in display screen made by correction can be limited to only a change in blue. In addition, by correcting other color components in addition to a blue component, the detection accuracy for a touch position can be increased.

### BRIEF DESCRIPTION OF THE DRAWINGS

FIG. 1 is a block diagram showing a configuration of a liquid crystal display device according to a first embodiment of the present invention.

FIG. 2 is a block diagram showing a detailed configuration of a liquid crystal panel of the device shown in FIG. 1.

FIG. 3 is a diagram showing a cross section of the liquid crystal panel and an arrangement position of a backlight of the device shown in FIG. 1.

FIG. 4A is a diagram showing the principle of a method of detecting a shadow image in the device shown in FIG. 1.

FIG. 43 is a diagram showing the principle of a method of detecting a reflection image in the device shown in FIG. 1.

FIG. 5A is a diagram showing an example of a scanned image including a shadow image of a finger.

FIG. 5B is a diagram showing an example of a scanned image including a shadow image of a finger and a reflection image of the ball of the finger.

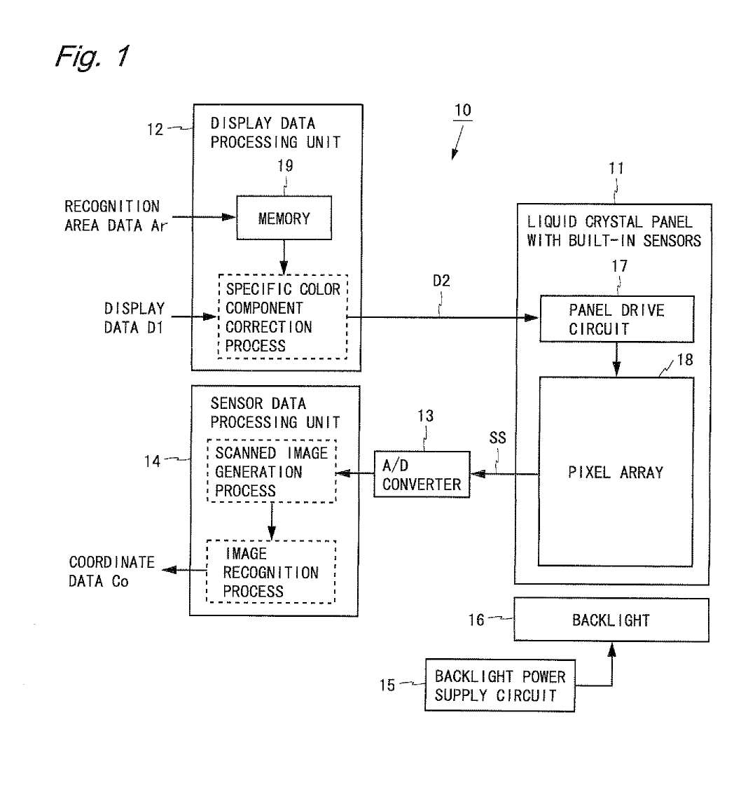

FIG. 6A is a diagram showing a correction characteristic of the device shown in FIG. 1, for a red component and a green component.

FIG. 6B is a diagram showing a correction characteristic of the device shown in FIG. 1, for a blue component.

FIG. 7 is a diagram showing an example of a display screen of the device shown in FIG. 1, together with recognition areas.

FIG. 8 is a flowchart showing an operation of the device shown in FIG. 1.

FIG. 9 is a timing chart of the device shown in FIG. 1.

FIG. 10 is a block diagram showing a configuration of a liquid crystal display device according to a second embodiment of the present invention.

FIG. 11 is a diagram showing an example of a display screen of the device shown in FIG. 10, together with a recognition area and a rough detected area.

FIG. 12 is a flowchart showing an operation of the device shown in FIG. 10.

### DESCRIPTION OF THE REFERENCE NUMERALS

1 PIXEL CIRCUIT
2 OPTICAL SENSOR
6 PHOTODIODE
10 and 20 LIQUID CRYSTAL DISPLAY DEVICE
11 LIQUID CRYSTAL PANEL WITH BUILT-IN SENSORS
12 and 22 DISPLAY DATA PROCESSING UNIT
13 A/D CONVERTER
14 and 24 SENSOR DATA PROCESSING UNIT
15 BACKLIGHT POWER SUPPLY CIRCUIT
16 BACKLIGHT
17 PANEL DRIVE CIRCUIT
18 PIXEL ARRAY
19 MEMORY
31 SCANNING SIGNAL LINE DRIVE CIRCUIT
32 DATA SIGNAL LINE DRIVE CIRCUIT
33 SENSOR ROW DRIVE CIRCUIT
34 SENSOR OUTPUT AMPLIFIER
35 to 38 SWITCH
51 OUTSIDE LIGHT
52 BACKLIGHT LIGHT
53 OBJECT
61 and 71 DISPLAY SCREEN
62 and 72 RECOGNITION AREA
73 ROUGH DETECTED AREA

### BEST MODE FOR CARRYING OUT THE INVENTION

### First Embodiment

FIG. 1 is a block diagram showing a configuration of a liquid crystal display device according to a first embodiment of the present invention. A liquid crystal display device 10 shown in FIG. 1 includes a liquid crystal panel with built-in sensors 11, a display data processing unit 12, an A/D converter 13, a sensor data processing unit 14, a backlight power supply circuit 15, and a backlight 16.

The liquid crystal panel with built-in sensors 11 (hereinafter, referred to as the liquid crystal panel 11) includes a panel drive circuit 17 and a pixel array 18. The pixel array 18 includes a plurality of pixel circuits and a plurality of optical sensors which are arranged two-dimensionally (details will be described later). Display data D1 and recognition area data Ar are inputted to the liquid crystal display device 10 from an external source. The display data D1 includes a red component, a green component, and a blue component. The display data processing unit 12 corrects a specific color component in the display data D1 by referring to the recognition area data Ar and outputs corrected display data D2 (details will be described later). The panel drive circuit 17 writes voltages according to the corrected display data D2 into the pixel circuits of the liquid crystal panel 11. By this, an image based on the corrected display data D2 is displayed on the liquid crystal panel 11.

The backlight power supply circuit 15 supplies a power supply voltage to the backlight 16. The backlight 16 irradiates light (backlight light) to the back surface of the liquid crystal panel 11, based on the power supply voltage supplied from the backlight power supply circuit 15. The backlight 16 is configured by, for example, white LEDs (Light Emitting Diodes). Note that the backlight 16 can employ any configuration and may be configured by a combination of red, green, and blue LEDs or Cold Cathode Fluorescent Lamps (CCFLs).

The panel drive circuit 17 performs an operation of reading voltages according to the amount of received light from the optical sensors of the liquid crystal panel 11, in addition to an operation of writing voltages into the pixel circuits of the liquid crystal panel 11. Output signals from the optical sensors are outputted external to the liquid crystal panel 11, as a sensor output signal SS. The A/D converter 13 converts the analog sensor output signal SS to a digital signal. The sensor data processing unit 14 generates a digital image (hereinafter, referred to as a scanned image), based on the digital signal outputted from the A/D converter 13. The scanned image may include an image of a body to be detected (e.g., a finger, a pen, etc.; hereinafter referred to as an object) which is present in the vicinity of the front surface of the liquid crystal panel 11. The sensor data processing unit 14 performs an image recognition process for detecting the object, on the scanned image and thereby determines an object position in the scanned image and then outputs coordinate data Co representing a touch position.

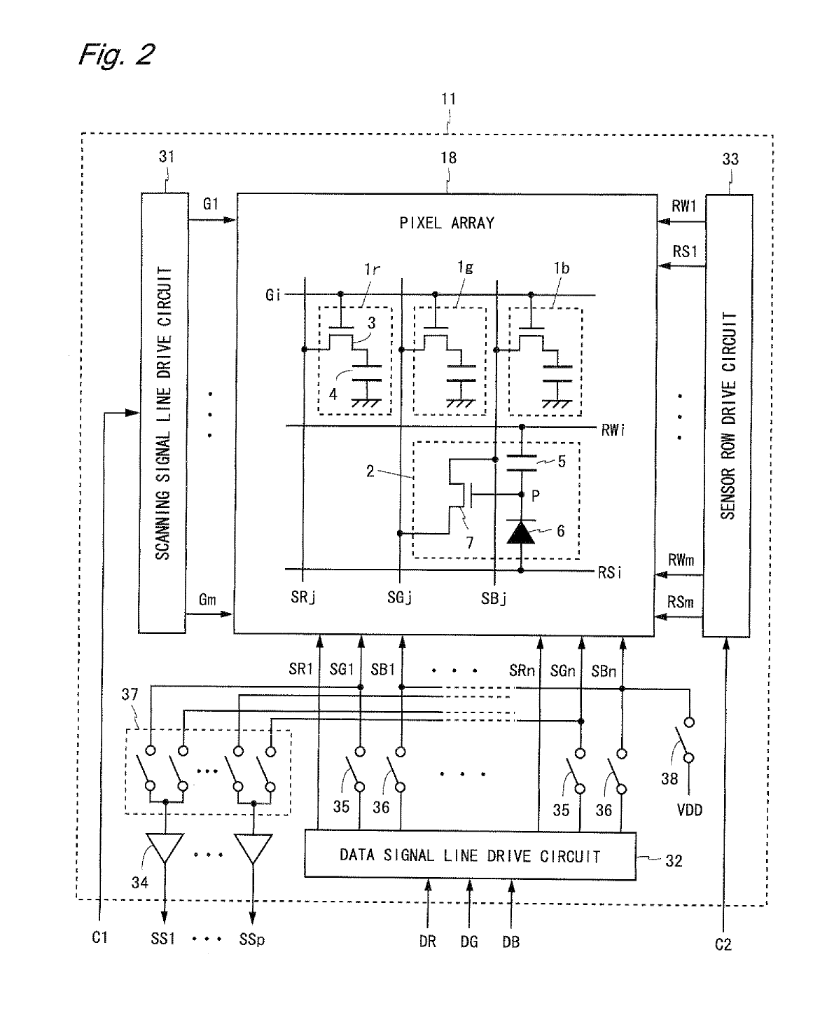

FIG. 2 is a block diagram showing a detailed configuration of the liquid crystal panel 11. As shown in FIG. 2, the pixel array 18 includes m scanning signal lines G1 to Gm; 3n data signal lines SR1 to SRn, SG1 to SGn, and SB1 to SBn; and (m×3n) pixel circuits 1. In addition, the pixel array 18 includes (m×n) optical sensors 2; m sensor read lines RW1 to RWm; and m sensor reset lines RS1 to RSm. The liquid crystal panel 11 is formed using CG (Continuous Grain) silicon.

The scanning signal lines G1 to Gm are arranged parallel to one another. The data signal lines SR1 to SRn, SG1 to SGn, and SB1 to SBn are arranged parallel to one another so as to vertically intersect the scanning signal lines G1 to Gm. The sensor read lines RW1 to RWm and the sensor reset lines RS1 to RSm are arranged parallel to the scanning signal lines G1 to Gm.

The pixel circuits 1 are respectively provided near intersections of the scanning signal lines G1 to Gm and the data signal lines SR1 to SRn, SG1 to SGn, and SB1 to SBn. The pixel circuits 1 as a whole are arranged two-dimensionally such that m pixel circuits 1 are arranged in a column direction (a vertical direction in FIG. 2) and 3n pixel circuits 1 are arranged in a row direction (a horizontal direction in FIG. 2). The pixel circuits 1 are classified into an R pixel circuit 1r, a G pixel circuit 1g, and a B pixel circuit 1b, depending on the color of a color filter provided. The three types of pixel circuits 1r, 1g, and 1b are arranged side by side in the row direction and three pixel circuits 1r, 1g, and 1b form one pixel.

Each, pixel circuit 1 includes a TET (Thin Film Transistor) 3 and a liquid crystal capacitance 4. A gate terminal of the TFT 3 is connected to a corresponding scanning signal line G1 (i is an integer between 1 and m inclusive), a source terminal is connected to any one of the data signal lines SRj, SGj, and SBj (j is an integer between 1 and n inclusive), and a drain terminal is connected to one electrode of the liquid crystal capacitance 4. To the other electrode of the liquid crystal capacitance 4 is applied a common electrode voltage. The data signal lines SG1 to SGn connected to the G pixel circuits 1g are hereinafter referred to as the G data signal lines and the data signal lines SB1 to SBn connected to the B pixel circuits 1b as the B data signal lines. Note that each pixel circuit 1 may include an auxiliary capacitance.

The light transmittance of a pixel circuit 1 (the luminance of a sub-pixel) is determined by a voltage written into the pixel circuit 1. To write a certain voltage into a pixel circuit 1 connected to a scanning signal line G1 and a data signal line SXj (X is any one of R, G, and B), a high-level voltage (voltage that places a TET 3 in an on state) is applied to the scanning signal line G1 and a voltage to be written is applied to the data signal line SXj. By writing a voltage according to display data D2 into the pixel circuit 1, the luminance of the sub-pixel can be set to a desired level.

Each optical sensor 2 includes a capacitor 5, a photodiode 6, and a sensor preamplifier 7 and is provided for each pixel. One electrode of the capacitor 5 is connected to a cathode terminal of the photodiode 6 (hereinafter, this connecting point is referred to as the node P). The other electrode of the capacitor 5 is connected to a corresponding sensor read line RWi and an anode terminal of the photodiode 6 is connected to a corresponding sensor reset line RSi. The sensor preamplifier 7 is configured by a TFT having a gate terminal connected to the node P and having a drain terminal connected to a corresponding B data signal line SBj and having a source terminal connected to a corresponding G data signal line SGj.

To detect an amount of light by an optical sensor 2 connected to a sensor read line RWi, a B data signal line SBj, etc., a predetermined voltage is applied to the sensor read line RWi and a sensor reset line RSi, and a power supply voltage VDD is applied to the B data signal line SBj. After the predetermined voltage is applied to the sensor read line RWi and the sensor reset line RSi, when light enters a photodiode 6, a current according to the amount of entered light flows through the photodiode 6 and the voltage at the node P decreases by an amount corresponding to the amount of current having flown through. When a power supply voltage VDD is applied to the B data signal line SBj, the voltage at the node P is amplified by the sensor preamplifier 7 and thus the amplified voltage is outputted to a G data signal line SGj. Accordingly, based on the voltage of the G data signal line SGj, the amount of light detected by the optical sensor 2 can be determined.

Around the pixel array 18 are provided a scanning signal line drive circuit 31, a data signal line drive circuit 32, a sensor row drive circuit 33, p sensor output amplifiers 34 (p is an integer between 1 and n inclusive), and a plurality of switches 35 to 38. The scanning signal line drive circuit 31, the data signal line drive circuit 32, and the sensor row drive circuit 33 correspond to the panel drive circuit 17 in FIG. 1.

The data signal line drive circuit 32 has 3n output terminals for the respective 3n data signal lines. The switches 35 are respectively provided between the G data signal lines SG1 to SGn and n output terminals provided for the respective G data signal lines SG1 to SGn, and the switches 36 are respectively provided between the B data signal lines SB1 to SBn and n output terminals provided for the respective B data signal lines SB1 to SBn. The G data signal lines SG1 to SGn are divided into groups, each including p G data signal lines. One switch 37 is provided between a k-th G data signal line in a group (k is an integer between 1 and p inclusive) and an input terminal of a k-th sensor output amplifier 34. All the B data signal lines SB1 to SBn are connected to one end of the switch 38. To the other end of the switch 38 is applied a power supply voltage VDD. In FIG. 2, the respective numbers of the switches 35 to 37 are n and the number of the switches 38 is 1.

In the liquid crystal display device 10, one frame time is divided into a display period during which signals (voltage signals according to display data) are written into the pixel circuits and a sensing period during which signals (voltage signals according to the amount of received light) are read from the optical sensors. The circuits shown in FIG. 2 perform operations that differ between the display period and the sensing period. During the display period, the switches 35 and 36 are placed in an on state and the switches 37 and 38 are placed in an off state. During the sensing period, on the other hand, the switches 35 and 36 are placed in an off state and the switch 38 is placed in an on state and the switches 37 are placed in an on state in a time-division manner such that the G data signal lines SG1 to SGn are connected in turn to the input terminals of the sensor output amplifiers 34 on a group-by-group basis.

During the display period, the scanning signal line drive circuit 31 and the data signal line drive circuit 32 operate. The scanning signal line drive circuit 31 selects, every line time, one scanning signal line from among the scanning signal lines G1 to Gm according to a timing control signal C1, and applies a high-level voltage to the selected scanning signal line and applies a low-level voltage to the other scanning signal lines. The data signal line drive circuit 32 drives the data signal lines SR1 to SRn, SG1 to SGn, and SB1 to SBn by a line sequential system, based on display data DR, DG, and DB outputted from the display data processing unit 12. More specifically, the data signal line drive circuit 32 stores at least a portion of each of the display data DR, DG, and DB for one row and applies, every line time, voltages according to the display data for one row to the data signal lines SR1 to SRn, SG1 to SGn, and SB1 to SBn. Note that the data signal line drive circuit 32 may drive the data signal lines SR1 to SRn, SGI to SGn, and SB1 to SBn by a dot sequential system.

During the sensing period, the sensor row drive circuit 33 and the sensor output amplifiers 34 operate. The sensor row drive circuit 33 selects, every line time, one each from the sensor read lines RW1 to RWm and the sensor reset lines RS1 to RSm according to a timing control signal C2, and applies a predetermined read voltage and a predetermined reset voltage to the selected sensor read line and sensor reset line, respectively, and applies a voltage different than that applied upon selection, to the other signal lines. Note that typically the length of one line time differs between the display period and the sensing period. The sensor output amplifiers 34 amplify voltages selected by their respective corresponding switches 37 and output the amplified voltages as sensor output signals SS1 to SSp.

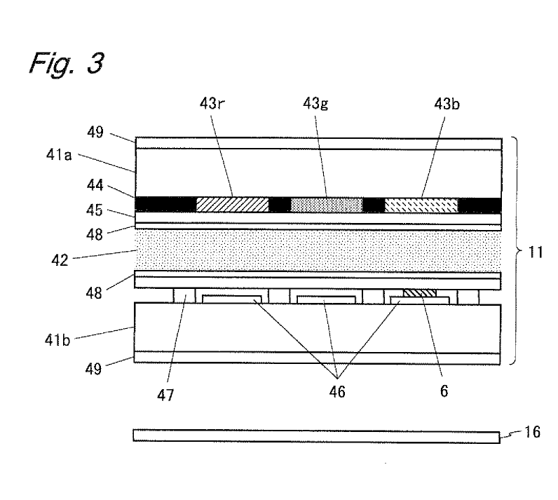

FIG. 3 is a diagram showing a cross section of the liquid crystal panel 11 and an arrangement position of the backlight 16. The liquid crystal panel 11 has a structure in which a liquid crystal layer 42 is sandwiched between two glass substrates 41a and 41b. One glass substrate 41a has color filters 43r, 43g, and 43b of three colors, light-shielding films 44, a counter electrode 45, etc., provided thereon. The other glass substrate 41b has pixel electrodes 46, data signal lines 47, optical sensors 2, etc., provided thereon. As shown in FIG. 3, a photodiode 6 included in an optical sensor 2 is provided near a pixel electrode 46 where a blue color filter 43b is provided (the reason will be described later). Alignment films 48 are respectively provided on surfaces of the glass substrates 41a and 41b that face each other, and polarizing plates 49 are respectively provided on the other surfaces. Of the two surfaces of the liquid crystal panel 11, a surface on the side of the glass substrate 41a serves as the front surface and a surface on the side of the glass substrate 41b serves as the back surface. The backlight 16 is provided on the back surface side of the liquid crystal panel 11.

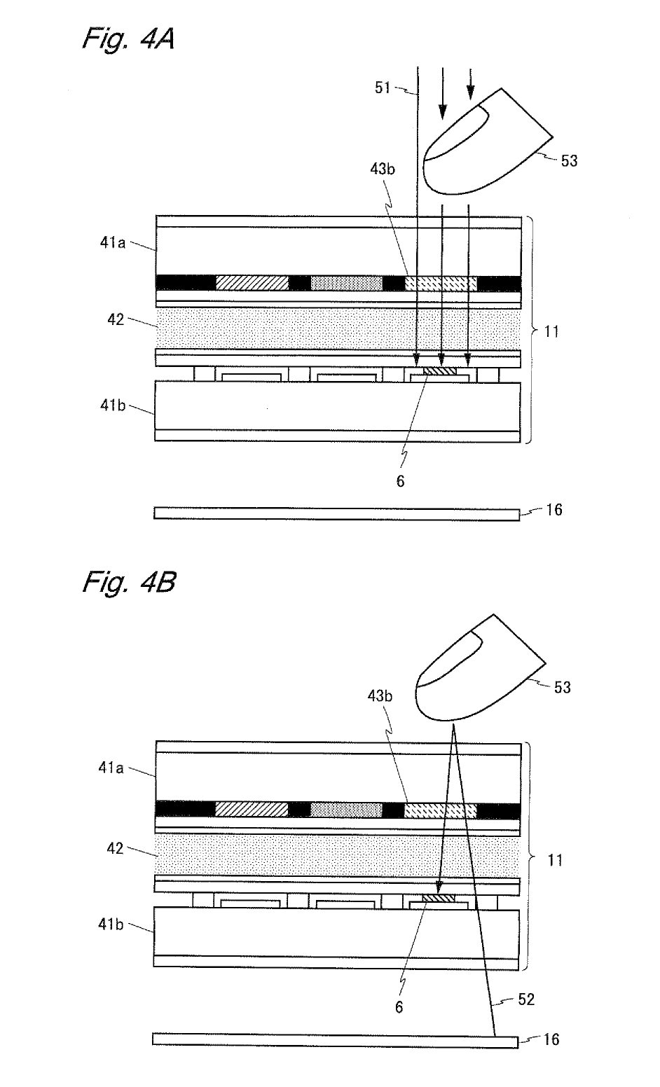

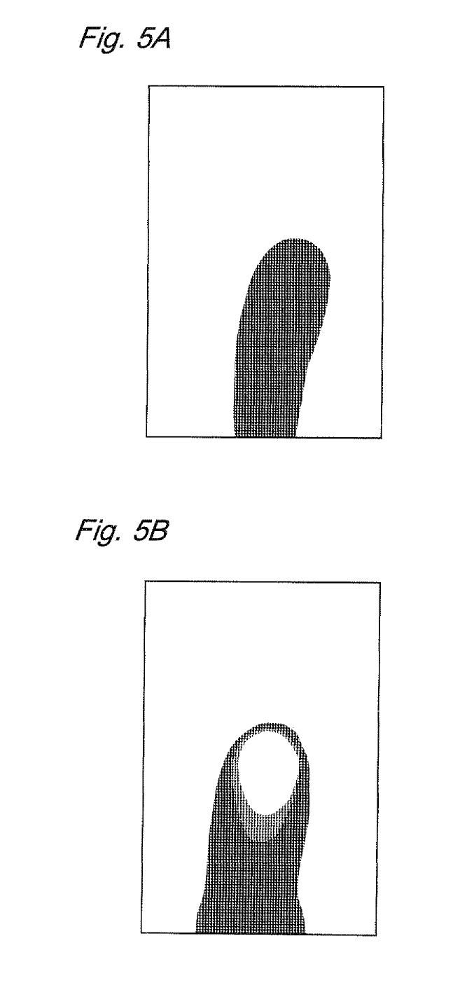

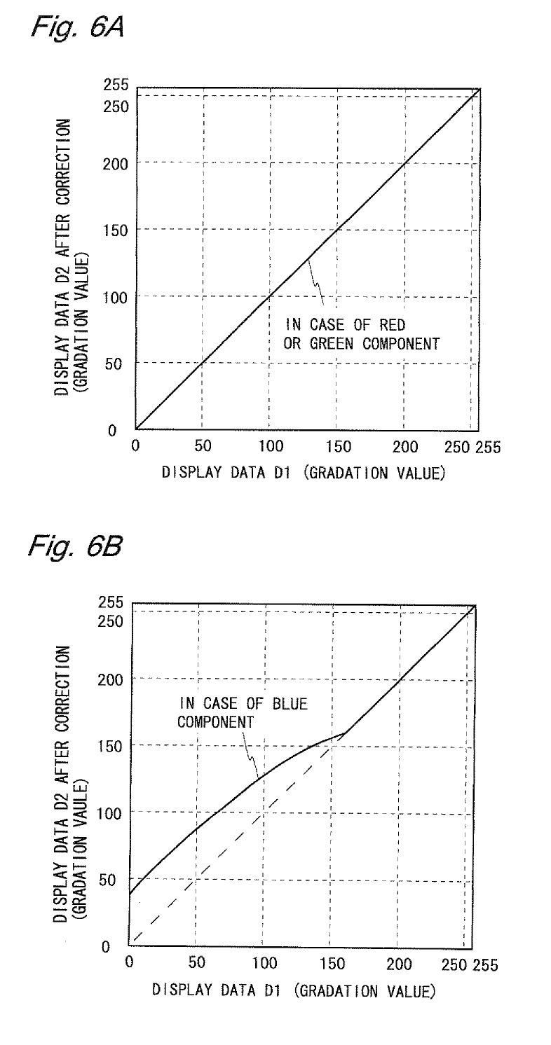

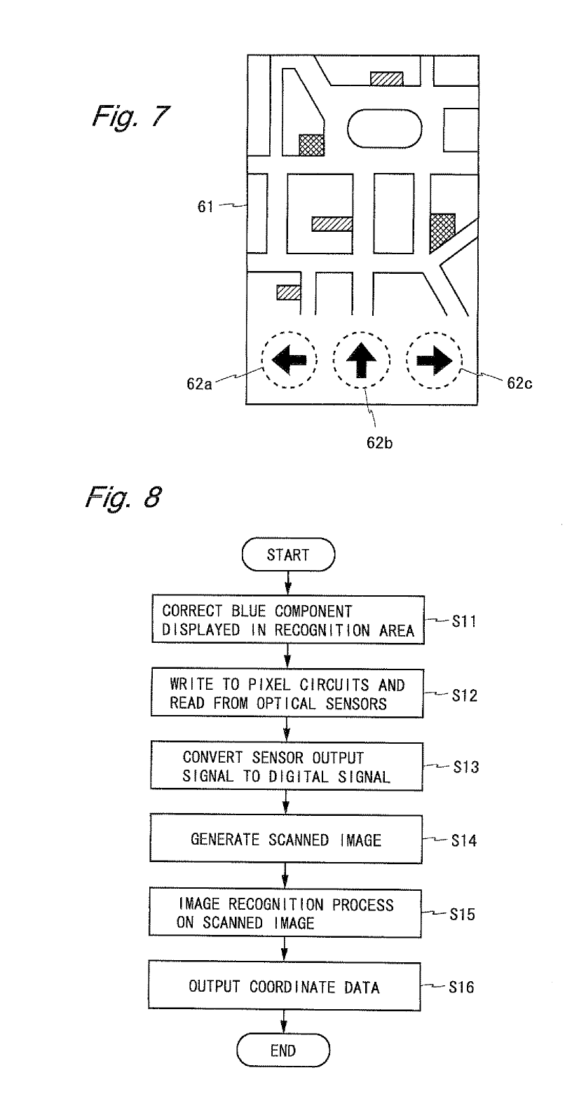

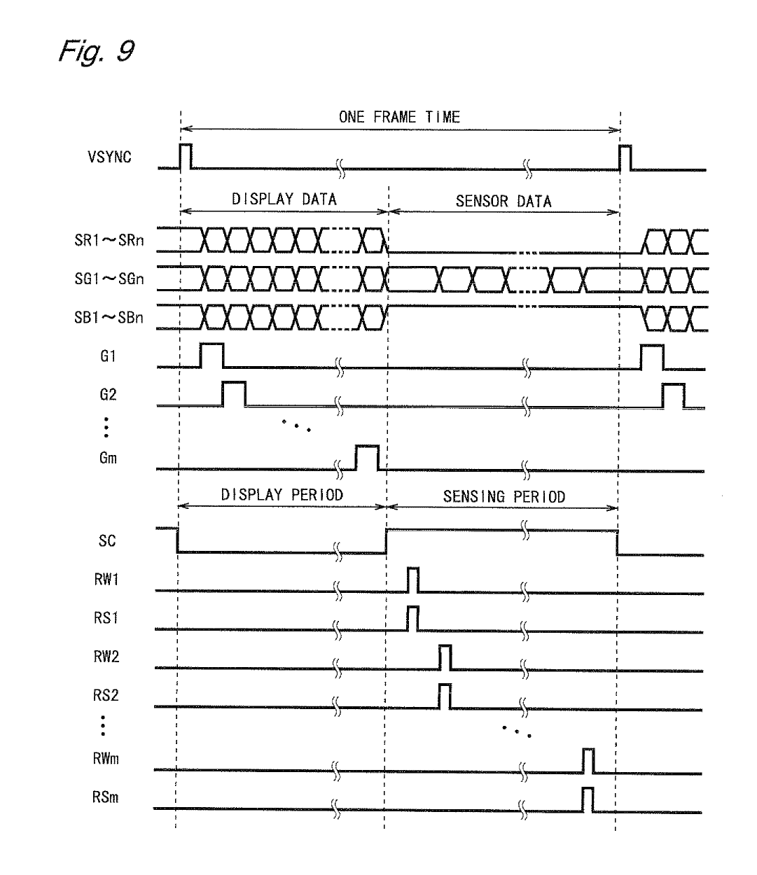

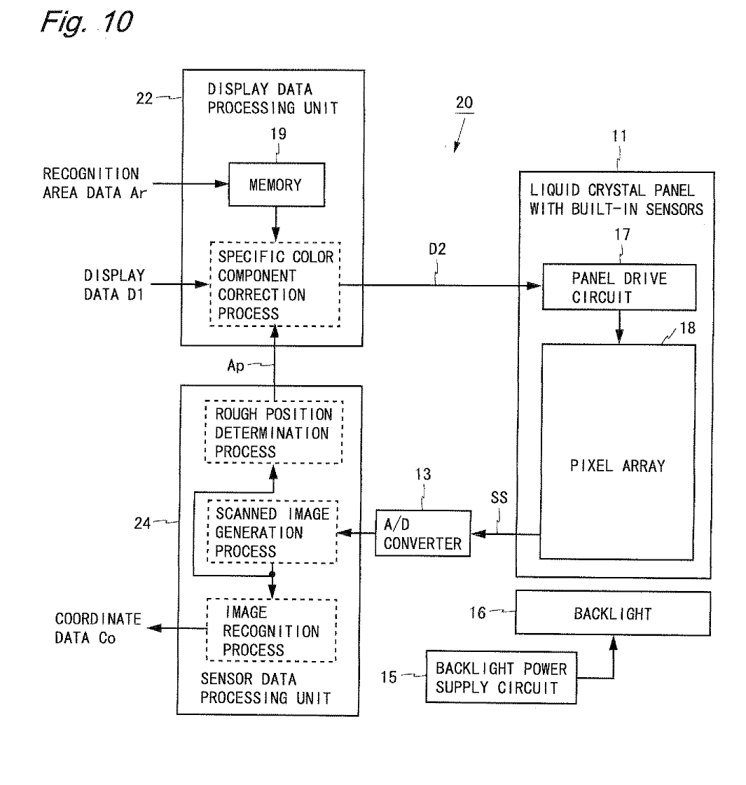

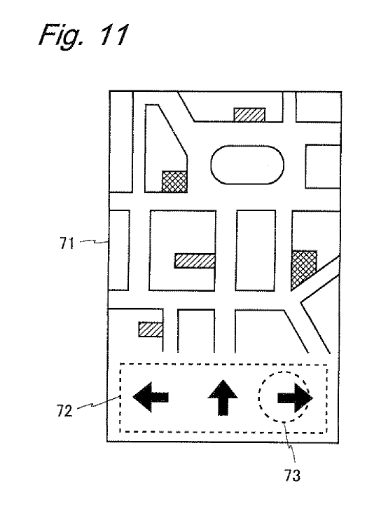

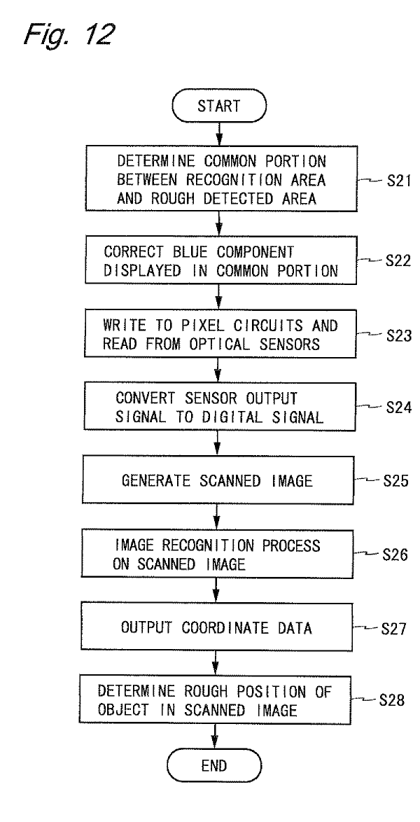

When the liquid crystal display device 10 detects a touch position on a display screen, the liquid crystal display device 10 uses one of a method of detecting a shadow image and a method of detecting a reflection image (or both a shadow image and a reflection image). FIG. 4A is a diagram showing the principle of the method of detecting a shadow image and FIG. 4B is a diagram showing the principle of the method of detecting a reflection image. In the method of detecting a shadow image (FIG. 4A), an optical sensor 2 including a photodiode 6 detects outside light 51 having passed through the glass substrate 41a, the liquid crystal layer 42, etc. At this time, when an object 53 such as a finger is present in the vicinity of the front surface of the liquid crystal panel 11, outside light 51 to enter the optical sensor 2 is blocked by the object 53. Thus, using the optical sensor 2, a shadow image of the object 53 by the outside light 51 can be detected.

In the method of detecting a reflection image (FIG. 4B), an optical sensor 2 including a photodiode 6 detects reflected light of backlight light 52. More specifically, backlight light 52 emitted from the backlight 16 passes through and gets out of the liquid crystal panel 11 through the front surface of the liquid crystal panel 11. At this time, when an object 53 is present in the vicinity of the front surface of the liquid crystal panel 11, the backlight light 52 is reflected off the object 53. For example, the balls of human fingers reflect light well. The reflected light of the backlight light 52 passes through the glass substrate 41a, the liquid crystal layer 42, etc., and enters the optical sensor 2. Thus, using the optical sensor 2, a reflection image of the object 53 by the backlight light 52 can be detected.

By using the above-described two methods in combination, both a shadow image and a reflection image can be detected. That is, using an optical sensor 2, a shadow image of an object 53 by outside light 51 and a reflection image of the object 53 by backlight light 52 can be simultaneously detected.

FIGS. 5A and 55 are diagrams showing examples of a scanned image including an image of a finger. A scanned image shown in FIG. 5A includes a shadow image of a finger, and a scanned image shown in FIG. 55 includes a shadow image of a finger and a reflection image of the ball of the finger. The sensor data processing unit 14 performs an image recognition process on such a scanned image and outputs coordinate data Co representing a touch position.

When the liquid crystal panel 11 is formed of CG silicon, the light reception sensitivity of the photodiodes 6 is high for blue light and is low for red light and green light. Hence, to facilitate the reception of blue light, as shown in FIG. 3, a photodiode 6 is provided near a pixel electrode 46 where a blue color filter 43b is provided. By thus arranging a photodiode 6 in a position where light of a color with a high light reception sensitivity is easily received, the amount of light detected by the photodiode 6 increases, enabling to increase the light reception sensitivity of an optical sensor 2.

A detail of the display data processing unit 12 will be described below. The display data processing unit 12 corrects those gradation values of a color component with a high light reception sensitivity of the optical sensors 2 among three color components included in display data D1 that are less than or equal to a predetermined value, to high values. When the liquid crystal panel 11 is formed of CG silicon, the light reception sensitivity of the optical sensors 2 is maximum for blue light among red light, green light, and blue light. Hence, the display data processing unit 12 treats a blue component among three color components included in display data D1 as a correction target color component and thus corrects those gradation values included in the blue component that are less than or equal to a predetermined value, to high values. Note that the display data processing unit 12 may correct those gradation values included not only in a blue component but also in a red component and a green component that are less than or equal to the predetermined value, to high values.

FIGS. 6A and 6B are diagrams showing examples of a correction characteristic of the display data processing unit 12. Here, a minimum value of display data D1 and corrected display data D2 is a 0 gradation value and a maximum value is a 255 gradation value. In this example, the display data processing unit 12 does not correct a red component and a green component but corrects those gradation values of a blue component that are less than or equal to a 160 gradation value, to high values.

In addition, the display data processing unit 12 corrects only such data for a blue component being the correction target color component that is displayed in a recognition area set on a display screen. FIG. 7 is a diagram showing an example of a display screen of the liquid crystal display device 10, together with recognition areas. A display screen 61 shown in FIG. 7 displays a map and three arrows (three circles indicated by dashed lines are illustrative only and are not displayed on the screen). Recognition areas 62a to 62c are respectively set to three arrow positions. By a user's finger touching any of the arrows, the content of the map changes.

A recognition area is identified by using recognition area data. Ar which is provided from a source external to the liquid crystal display device 10. To identify a rectangular recognition area, the coordinates of upper left and lower right vertices of a rectangle may be used as recognition area data. To identify a recognition area of an arbitrary shape, bitmap data representing the inside or outside of the recognition area on a pixel-by-pixel basis may be used as recognition area data.

As shown in FIG. 1, the display data processing unit 12 includes a memory 19. The memory 19 stores recognition area data Ar provided from an external source. The display data processing unit 12 determines a recognition area by using the recognition area data stored in the memory 19 and corrects only such data for a blue component that is displayed in the recognition area. As such, the display data processing unit 12 receives recognition area data Ar from an external source and corrects only such data for a correction target color component (blue component) that is displayed in a recognition area which is identified by using the recognition area data Ar.

FIG. 8 is a flowchart showing an operation of the liquid crystal display device 10. The liquid crystal display device 10 performs an operation shown in FIG. 8 every frame time. First, the display data processing unit 12 corrects only a blue component in display data D1 by referring to recognition area data Ar (step S11). At step S11, by correcting only such a blue component that is displayed in a recognition area, corrected display data D2 is obtained. Then, the panel drive circuit 17 performs an operation of writing voltages according to the corrected display data D2 into the pixel circuits 1 and an operation of reading voltages according to the amount of received light, from the optical sensors 2 (step S12). Then, the A/D converter 13 converts an analog sensor output signal SS outputted from the liquid crystal panel 11, to a digital signal (step S13).

Then, the sensor data processing unit 14 generates a scanned image, based on the digital signal obtained at step S13 (step S14). The sensor data processing unit 14 then performs an image recognition process on the scanned image generated at step S14 and thereby determines an object position in the scanned image (step S15). At step S15, a process of detecting a shadow image, a reflection image or both of an object is performed. Then, the sensor data processing unit 14 outputs, based on a result of the image recognition process at step S15, coordinate data Co representing a touch position, external to the liquid crystal display device 10 (step S16).

FIG. 9 is a timing chart of the liquid crystal display device 10. As shown in FIG. 9, a vertical synchronizing signal VSYNC goes to a high level every frame time. One frame time is divided into a display period and a sensing period. A sense signal SC is a signal indicating whether the period is a display period or a sensing period. The sense signal SC is at a low level during the display period and is at a high level during the sensing period.

During the display period, the switches 35 and 36 are placed in an on state and all the data signal lines SR1 to SRn, SG1 to SGn, and SB1 to SBn are connected to the data signal line drive circuit 32. During the display period, first, the voltage of the scanning signal line G1 goes to a high level. Then, the voltage of the scanning signal line G2 goes to a high level and thereafter the voltages of the scanning signal lines G3 to Gm go to a high level in turn. During a period during which the voltage of a scanning signal line G1 is at a high level, voltages to be written into 3n pixel circuits 1 connected to the scanning signal line G1 are applied to the data signal lines SR1 to SRn, SG1 to SGn, and SB1 to SBn.

During the sensing period, the switch 38 is placed in an on state and the switches 37 are placed in an on state in a time-division manner. Hence, a power supply voltage VDD is fixedly applied to the B data signal lines SB1 to SBn, and the G data signal lines SG1 to SGn are connected to the input terminals of the sensor output amplifiers 34 in a time-division manner. During the sensing period, first, a sensor read line RW1 and a sensor reset line RS1 are selected. Then, a sensor read line RW2 and a sensor reset line RS2 are selected and thereafter the sensor read lines RW3 to RWm and the sensor reset lines RS3 to RSm are selected in turn on a pair-by-pair basis. A read voltage and a reset voltage are respectively applied to the selected sensor read line and sensor reset line. During a period during which a sensor read line RWi and a sensor reset line RSi are selected, voltages according to the amounts of light detected by the respective n optical sensors 2 connected to the sensor read line RWi are respectively outputted to the G data signal lines SG1 to SGn.

The effects of the liquid crystal display device 10 according to the present embodiment will be described below.

As described above, when the liquid crystal panel 11 is formed of OG silicon, the light reception sensitivity of the optical sensors 2 is maximum for blue light among red light, green light, and blue light. Taking into account the fact that the optical sensors 2 have such a characteristic, the display data processing unit 12 corrects those gradation values of a blue component among three color components included in display data D1 that are less than or equal to a predetermined value, to high values.

By thus correcting a color component (blue component) in display data D1 that has a high light reception sensitivity of the optical sensors 2, a displayed image can be converted to an image that is easy to recognize and thus a touch position can be detected properly irrespective of the displayed image. Particularly, by correcting low gradation values included in a correction target color component to high values, even when a displayed image is dark and accordingly the amount of light detected by the optical sensors 2 is small, the amount of light detected by the optical sensors 2 is increased to brighten an object image, enabling to properly detect a touch position. Particularly, by correcting only low gradation values included in a specific color component, a change in display screen made by correction can be limited to only a change in specific color. In addition, by correcting other color components in addition to the specific color component, the detection accuracy for a touch position can be increased.

The display data processing unit 12 corrects only such data for a correction target color component that is displayed in a recognition area set on a display screen. By this, while a change in display screen made by correction is limited to only within a specific area, a touch position can be detected properly. Particularly, by identifying a recognition area by using recognition area data Ar which is provided from a source external to the liquid crystal display device 10, a touch position can be detected properly while a change in display screen made by correction is limited to within a specific area which is set in a free position according to a usage mode, etc., from the source external to the liquid crystal display device 10.

By the display data processing unit 12 performing an image recognition process on a scanned image, an object (a finger, etc.) included in the scanned image can be detected by the liquid crystal display device 10. In addition, when a reflection image of an object is detected, a scanned image is darkened and thus a problem of a decrease in the detection accuracy for a touch position becomes remarkable. However, even in such a case, by correcting a color component (blue component) in display data D1 that has a high light reception sensitivity of the optical sensors, a displayed image can be converted to an image that is easy to recognize and thus a touch position can be detected properly irrespective of the displayed image.

### Second Embodiment

FIG. 10 is a block diagram showing a configuration of a liquid crystal display device according to a second embodiment of the present invention. A liquid crystal display device 20 shown in FIG. 10 is such that in the liquid crystal display device 10 (FIG. 1) according to the first embodiment the display data processing unit 12 and the sensor data processing unit 14 are respectively replaced by a display data processing unit 22 and a sensor data processing unit 24. Of the components in the present embodiment, the same components as those in the first embodiment are denoted by the same reference numerals and description thereof is omitted.

As with the sensor data processing unit 14 according to the first embodiment, the sensor data processing unit 24 performs a process of generating a scanned image and an image recognition process on the scanned image. In addition, the sensor data processing unit 24 determines a rough position of an object in the scanned image and outputs rough position data Ap representing the determined position.

As with the display data processing unit 12 according to the first embodiment, the display data processing unit 22 corrects those gradation values of a blue component included in display data D1 that are less than or equal to a predetermined value, to high values. Note, however, that the display data processing unit 22 determines a recognition area by using recognition area data Ar which is stored in a memory 19, and determines a rough detected area by using the rough position data Ap which is outputted from the sensor data processing unit 24 and corrects only such data for a blue component that is displayed within a common portion between the recognition area and the rough detected area.

FIG. 11 is a diagram showing an example of a display screen of the liquid crystal display device 20, together with a recognition area and a rough detected area. A display screen 71 shown in FIG. 11 displays a map and three arrows (a rectangle and a circle indicated by dashed lines are illustrative only and are not displayed on the screen). A recognition area 72 including the three arrows is set on the display screen 71. By a user's finger touching any of the arrows, the content of the map changes.

When the user's finger approaches the front surface of the liquid crystal panel 11, the sensor data processing unit 24 outputs rough position data Ap representing a rough position of the finger in a scanned image. FIG. 11 shows that a rough detected area 73 which is identified by using the rough position data Ap is superimposed on the display screen 71. The display data processing unit 22 corrects only such data for a blue component that is displayed within a common portion between the recognition area 72 and the rough detected area 73. Hence, when the user's finger approaches the display screen 71, a portion of the display screen 71 close to the finger turns slightly blue.

FIG. 12 is a flowchart showing an operation of the liquid crystal display device 20. The liquid crystal display device 20 performs an operation shown in FIG. 12 every frame time. Steps S23 to 527 shown in FIG. 12 are the same as steps S12 to S16 shown in FIG. 8. Subsequent to step S27, the sensor data processing unit 24 determines, based on a scanned image generated at step S25, a rough position of an object in the scanned image (step S28). Rough position data Ap obtained at step S28 is referred to when a next frame is displayed.

When the next frame is displayed, the display data processing unit 22 determines a common portion between a recognition area which is identified by using recognition area data Ar stored in the memory 19 and a rough detected area which is identified by using the rough position data Ap outputted from the sensor data processing unit 24 (step S21). Then, the display data processing unit 22 corrects only a blue component in display data D1 by referring to the common portion determined at step S21 (step S22). At step S22, by correcting only such a blue component that is displayed within the common portion, corrected display data D2 is obtained. Thereafter, at steps S23 to S27, the liquid crystal display device 20 operates in the same manner as the liquid crystal display device 10 according to the first embodiment.

As such, in the liquid crystal display device 20 according to the present embodiment, the display data processing unit 22 determines a rough position of an object in a scanned image, and the sensor data processing unit 24 determines correction target data, based on a recognition area which is set from a source external to the liquid crystal display device 20 and the rough position determined in the liquid crystal display device 20. By this, while a change in display screen made by correction is limited to only near an object, a touch position can be detected properly. In addition, since, when an object approaches a display screen, the color of a portion of the display screen close to the object changes, the user can be notified that the object is close to the display screen.

As described above, according to liquid crystal display devices according to the embodiments of the present invention, by correcting a color component with a high light reception sensitivity of optical sensors among a plurality of color components included in display data, a touch position can be detected properly irrespective of a displayed image.

Note that although in the first and second embodiments a panel drive circuit 17 is formed monolithically with a liquid crystal panel 11, all or part of the panel drive circuit 17 may be provided external to the liquid crystal panel. Note also that although in the liquid crystal panel 11 an optical sensor 2 is provided for each pixel, an optical sensor 2 may be provided for a plurality of pixels or may be provided for each sub-pixel. Although recognition area data Ar is provided from an external source to identify a recognition area, a recognition area may be fixedly set on a display screen. When the liquid crystal panel 11 is formed of amorphous silicon, the light reception sensitivity of photodiodes 6 is high for red light and is low for green light and blue light. Thus, in such a case, by reading blue as red, the same liquid crystal display devices as those in the first and second embodiments are configured. In addition, display devices other than liquid crystal display devices can also be configured by the above-described methods.

### INDUSTRIAL APPLICABILITY

Display devices of the present invention have a feature that a touch position can be detected properly irrespective of a displayed image, and thus, can be used as various display devices provided with optical sensors, such as a liquid crystal display device having a plurality of optical sensors provided in a liquid crystal panel.

1. A display device having a plurality of optical sensors, the display device comprising:
a display panel including a plurality of pixel circuits and a plurality of optical sensors which are arranged two-dimensionally;
a display data processing unit that corrects a color component with a high light reception sensitivity of the optical sensors among a plurality of color components which are included in display data; and
a drive circuit that performs an operation of writing a signal according to the corrected display data into the pixel circuits and an operation of reading a signal according to an amount of received light, from the optical sensors.

2. The display device according to claim 1, wherein the display data processing unit corrects a gradation value included in a correction target color component that is less than or equal to a predetermined value, to a high value.

3. The display device according to claim 2, wherein the display data processing unit corrects only such data for the correction target color component that is displayed in a recognition area set on a display screen.

4. The display device according to claim 3, wherein the display data processing unit receives recognition area data from an external source and corrects only such data for the correction target color component that is displayed in a recognition area which is identified by using the recognition area data.

5. The display device according to claim 4, further comprising a sensor data processing unit that performs an image recognition process on a scanned image generated based on the signal read from the optical sensors, to detect an object included in the scanned image, and outputs rough position data representing a rough position of the object in the scanned image, wherein
the display data processing unit corrects only such data for the correction target color component that is displayed in an area which is identified by using the recognition area data and the rough position data.

6. The display device according to claim 1, further comprising a sensor data processing unit that performs an image recognition process on a scanned image generated based on the signal read from the optical sensors, to detect an object included in the scanned image.

7. The display device according to claim 6, further comprising a backlight that irradiates light to a back surface of the display panel, wherein
the sensor data processing unit detects at least a reflection image of the object.

8. The display device according to claim 1, wherein
the display panel is a liquid crystal panel formed of CG (Continuous Grain) silicon, and
the display data processing unit corrects a blue component among the plurality of color components which are included in the display data.

9. A method of driving a display device having a display panel which includes a plurality of pixel circuits and a plurality of optical sensors which are arranged two-dimensionally, the method comprising the steps of:
correcting a color component with a high light reception sensitivity of the optical sensors among a plurality of color components which are included in display data;
writing a signal according to the corrected display data into the pixel circuits; and
reading a signal according to an amount of received light, from the optical sensors.
